(19) United States
(12) Patent Application Publication
(10) Pub. No.: US 2004/0126276 A1
(43) Pub. Date: Jul. 1, 2004

(54) Transport device

(75) Inventors: Gunter Ilgen, Bad Berneck (DE); Dietmar Glindemann, Halle (DE)

Correspondence Address: BROWDY AND NEIMARK, P.L.L.C., 624 Ninth Street, N.W., Washington, DC, 20001, US

(73) Assignee: University of Bayreuth, Bayreuth (DE)

(21) Appl. No.: 10/378,678

(22) Filed: Mar. 5, 2003

Related U.S. Application Data
(60) Provisional application No. 60/407,973, filed on Sep. 5, 2002.

(30) Foreign Application Priority Data
Mar. 6, 2002 (DE) 202 03 651.0
Aug. 26, 2002 (DE) 202 13 533

(51) Int. Cl. G01N 30/02

(52) U.S. Cl. 422/89

(57) ABSTRACT

A transport device for transporting an analyte from a gas chromatograph into a detector has a transfer line, connectable on its outlet side to the detector, and connected on its inlet side to a connection part which is connectable to a separating column of the gas chromatograph. An auxiliary gas connection feeds an auxiliary gas into the transfer line. Gas flowing out of the separating column into the transfer line is mixable with the auxiliary gas feed through the auxiliary gas connection, and a temperature profile which falls along the transfer line toward the detector is produced during measurement by a heating device acting on the transfer line.

The present invention relates to a transport device for transporting an analyte from a gas chromatograph into a detector, having a transfer line, connectable on the outlet side to the detector and connected on the inlet side to a connection part, which is connectable to a separating column of the gas chromatograph and which comprises an auxiliary gas connection for feeding an auxiliary gas into the transfer line.

A transport device of this type is known from the publication of De Smaele et al., “Capillary gas chromatography-ICP mass spectrometry: a powerful hyphenated technique for the determination of organometallic compounds”, J. Anal. Chem., 1996, Volume 355, p. 778. The known transport device is used for the purpose of conveying gaseous analytes from the separating column of a gas chromatograph to a mass spectrometer. The known transport device comprises a heated transfer line having an inner transport capillary. Through a T-shaped connection part introduced into the wall of the gas chromatograph, heated auxiliary gas may be fed into the transfer line from an auxiliary gas line into the space of the transfer line surrounding the transport capillary.

The known transport device has the disadvantage that the transfer line must be kept at temperatures in the range of 280° C. in order to be able to transport analytes having a boiling temperature in the range of 420° C.

Furthermore, a further transport device is known from Bayón et al., “An Alternative GC-ICP-MS Interface Design for Trace Elements Speciation”, Journal of Analytical Atomic Spectrometry, 1999, Volume 14, p. 1317. The known transport device is also used for the purpose of conveying gaseous analytes from the separating column of a gas chromatograph to a mass spectrometer. For this purpose, the outlet end of the separating column is introduced into a stainless-steel tube, which is introduced into the connection part of the transport device. The connection part is made T-shaped and has a lateral auxiliary gas connection, through which the auxiliary gas may be fed into the transfer line, which is connected to the outlet side of the connection part. On the inlet side, the connection part is connected to a short metal pipe, which leads through a metal block. The metal block is heated with the aid of a heating cartridge and keeps the connection part at a predetermined temperature.

It is noted in the publication that the gaseous analytes are conveyed rapidly to the detector by the auxiliary gas as it flows out. Because of this, the gaseous analytes cannot condense out in the transfer line. In addition, it is noted that the rapidly flowing protective gas forms a protective layer between analytes and the wall of the transfer line. Through this protective layer, condensing of the analytes onto the wall of the transfer line is additionally hindered.

A disadvantage of the transfer device is that it is only suitable for transporting materials having a boiling temperature below the boiling temperature of tributyl tin. This means that analytes having a boiling temperature above 400° C. cannot be transported through the transfer line without the analytes condensing out. In addition, the known transport device leads to a measurement error in regard to repeatability which increases from 1.5 to 5% from monobutyl tin to tributyl tin.

Starting from this related art, the present invention is based on the object of providing an improved transport device, using which high-boiling analytes may be conveyed from a gas chromatograph to a detector.

This object is achieved according to the present invention in that gas flowing out of the separating column into the transfer line is miscible with the auxiliary gas fed through the auxiliary gas connection and a temperature profile which falls along the transfer line toward the detector is producible during a measurement by a heating device acting on the transfer line.

The present invention is based on the realization that additional boiling point reduction is caused by the mixing of the auxiliary gas with the gaseous analytes, which leads to the transfer line being able to be kept at temperatures which are well below the temperature of the transfer lines of typical transport devices. In order for this effect to occur, however, sufficiently thorough mixing of the two gases is necessary. It is therefore advantageous if a part of the transfer line is kept at the highest possible temperature in the flow direction after the connecting part, in order to prevent the analytes from condensing out in a region having insufficient mixing. In its further course, the temperature may fall along the transfer line. If the temperature does not fall below the boiling temperature of the gas mixture, the diluted analytes do not condense out. According to the present invention, the transfer line is slightly heated in such a way that a sufficient temperature is ensured in the region in which an incompletely mixed gas mixture flows in the transfer line.

In a preferred embodiment, the connection part is positioned in the inside of the heating zone of the gas chromatograph. For this arrangement, no separate heating device is necessary to implement the temperature gradient. Rather, the connection part is kept at least near the operating temperature of the separating column in the heating zone of the gas chromatograph. In this way, it is ensured that the analytes do not condense out in the region of the connection part and the adjoining transfer line.

In a further preferred embodiment, the transfer line is manufactured from a metallic material having poor thermal conductivity, for example, stainless steel. A sufficiently flat temperature gradient may be produced using this material. In addition, it has been shown that transfer lines made of a metallic material may generally be attached more easily and more securely to the connecting part and the detector than the typical quartz capillaries.

In order to prevent the temperature of the transfer line from falling under a predetermined temperature, the transfer line must be heated in most applications. For example, it is possible to use the ohmic resistance of the transfer line and to apply current to the transfer line. In order to prevent overheating of the transfer line, a section of the transfer line positioned inside the heating zone of the gas chromatograph is short-circuited in this case. Because of this, the temperature of the transfer line in the heating zone of the gas chromatograph may not exceed the operating temperature of the gas chromatograph. Therefore, the danger also does not arise of the transfer line being locally overheated, which may lead to decomposition of the analytes under certain circumstances.

In a further preferred embodiment, a suction device is connected to the transfer line. This suction device may, for example, be a pump, which is particularly used for the purpose of suctioning off the solvent which comes out of the separating column before the analytes. This is particularly advantageous if the solvent impairs the functioning of the detector.

Finally, heating devices may be provided, through which the auxiliary gas flowing into the connection part may be preheated. Through this measure, local coolings in the transfer line are avoided, so that the analytes do not condense out. In addition, the gas flowing into the transfer line also acts as a thermostat, which prevents overheating of the electrically heatable transfer line and the gas flowing out of the separating column 6.

Further advantageous embodiments and refinements are the object of the dependent claims.

In the following, the present invention is described in detail on the basis of the attached drawing.

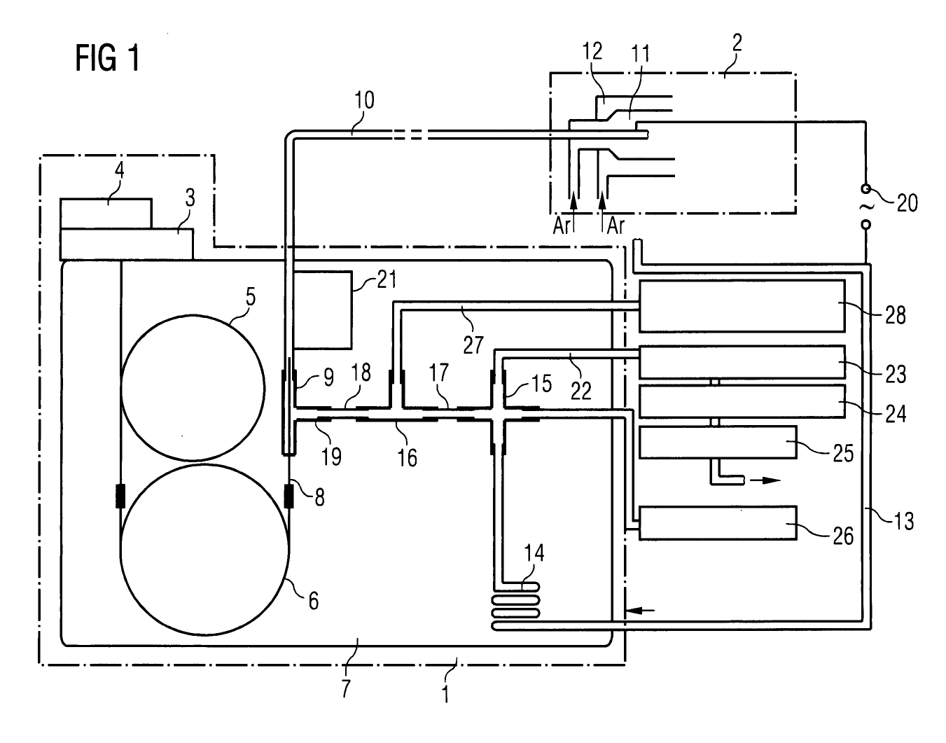

FIG. 1 shows a block diagram of a transport device which connects a gas chromatograph to a detector;

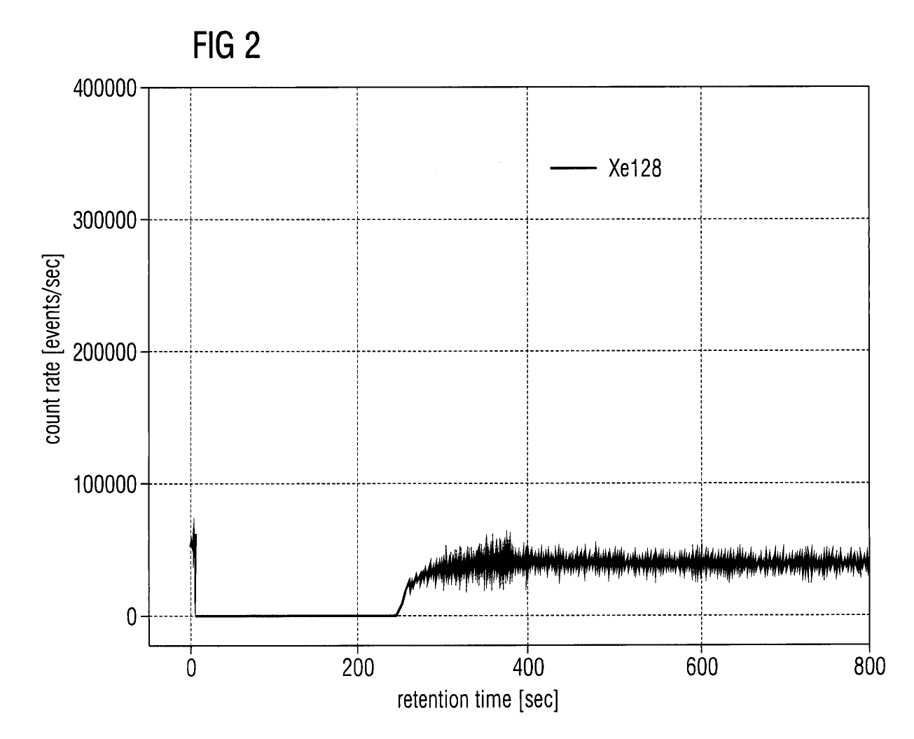

FIG. 2 shows a gas chromatogram of a carrier gas used for transporting the analytes in the separating column of the gas chromatograph;

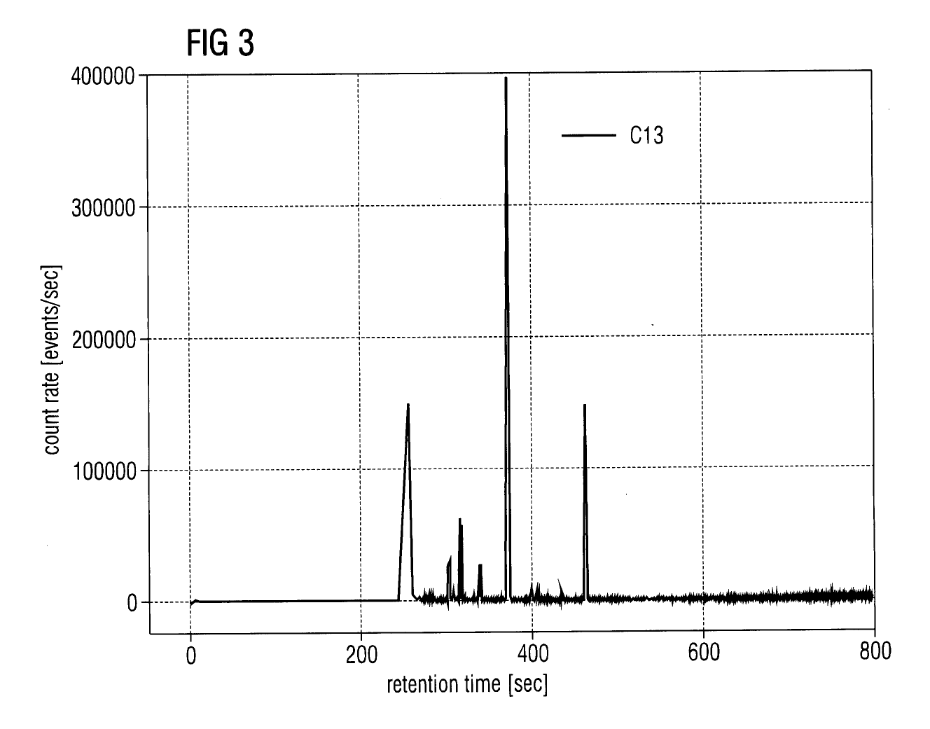

FIG. 3 shows a gas chromatogram of a solvent;

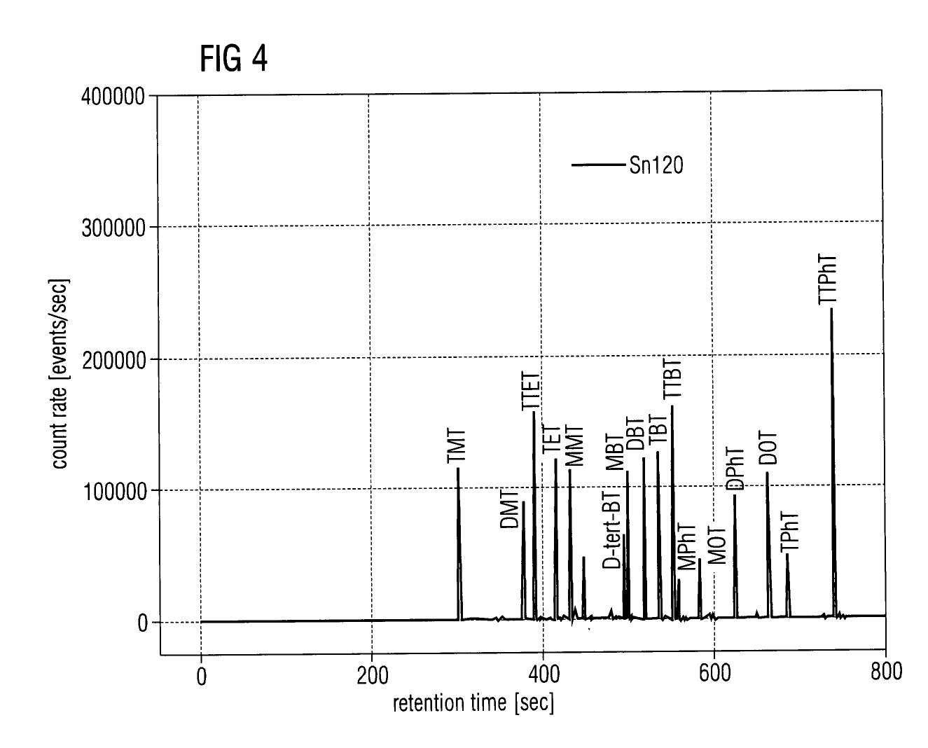

FIG. 4 shows a gas chromatogram of organotin compounds;

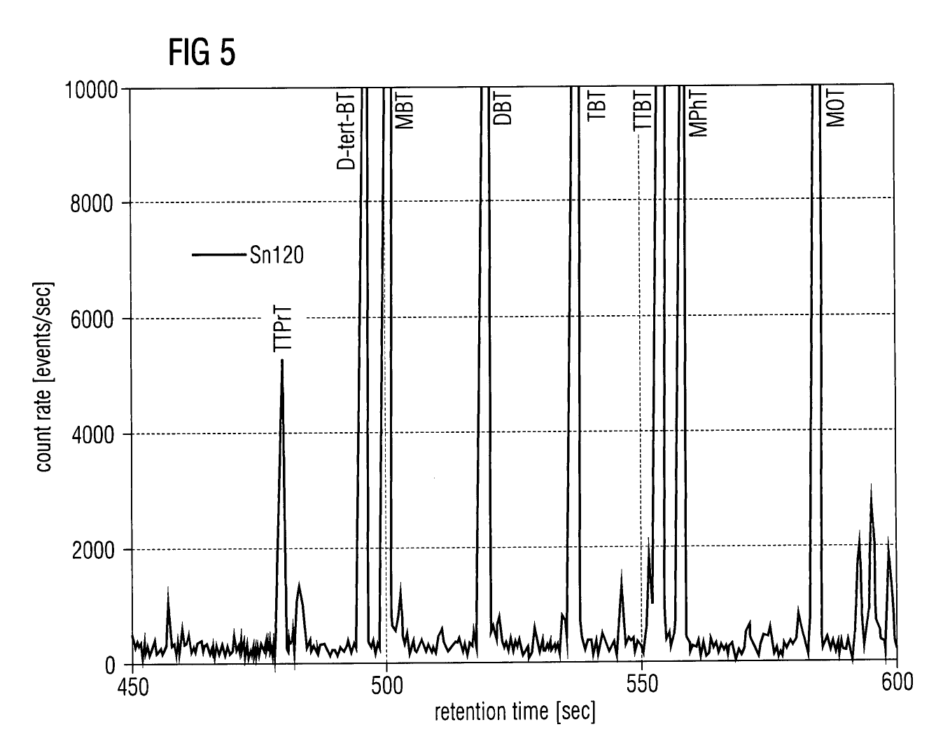

FIG. 5 shows an enlarged section from the gas chromatogram from FIG. 4; and

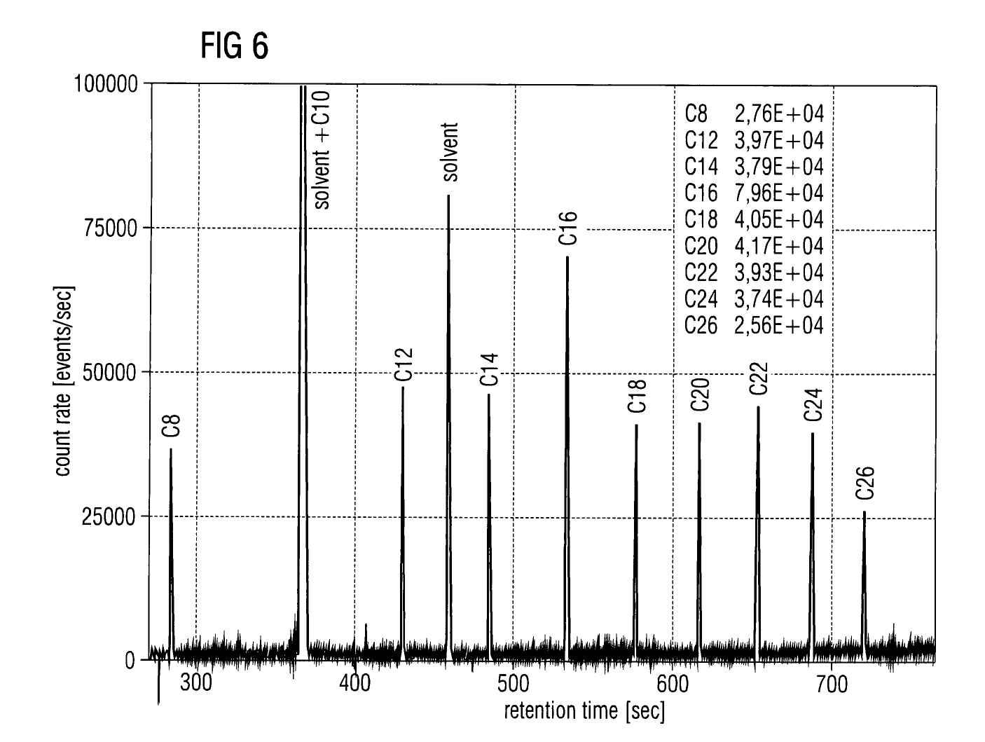

FIG. 6 shows a gas chromatogram of a calibration solution containing alkanes.

FIG. 1 shows a gas chromatograph 1 which is connected to a detector 2. The detector 2 may be an inductively coupled plasma mass spectrometer (ICP-MS) or an inductively coupled plasma atomic emission spectrometer (ICP-AES), an atomic absorption spectrometer (AAS), or an atomic fluorescence spectrometer (AFS). In the exemplary embodiment illustrated in FIG. 1, the detector is an ICP-MS.

The gas chromatograph 1 comprises an inlet 3, through which an injector 4 may inject samples into a pre-column 5 and from there into a separating column 6. The samples themselves include volumes of solvents in which materials to be analyzed are dissolved. The materials to be analyzed are also referred to as analytes. The pre-column 5 and the separating column 6 are each spiral-shaped lines in which the samples are separated according to their boiling temperature. For this purpose, the pre-column 5 and the separating column 6 are located in the heating zone 7 of the gas chromatograph 1, which may be heated with the aid of heating devices (not shown). The temperature pattern in the heating zone 7 follows a preset temperature profile over time. In particular, the heating procedure occurs using a predetermined heating rate, so that the analytes having a low boiling temperature leave the separating column 6 first. Subsequently, the analytes having higher boiling temperatures follow. Using the gas chromatograph 1 shown in FIG. 1, both high-boiling analytes having a boiling point <450° C. and ultra high-boiling analytes having a boiling point between 450° C. and 600° C. may be separated. An example of a high-boiling substance is a compound such as n-hexacosane paraffin or tetraphenyl tin. An example of an ultra high-boiling substance is, for example, petroleum, which has a boiling range reaching up to 600° C.

The analytes which leave the separating column 6 are introduced through a connection part 9 into a transfer line 10 via a capillary 8. In the case shown in FIG. 1, the capillary 8 projects approximately 2 cm into the transfer line 10. Finally, the analytes reach the detector 2, which is an inductively coupled plasma mass spectrometer (ICP-MS) in the present case, through the transfer line 10. In FIG. 1, a gas supply 11 for a positioning gas and a further gas supply 12 for a cooling gas are illustrated in the region of the detector 2 next to the transfer line 10, which leads to a plasma chamber and through which the analytes are introduced into the plasma chamber together with the carrier gas. The gas supplies 11 and 12 form the torch of the ICP-MS. The gas mixture of carrier gas and analytes is also referred to as nebulizer gas in the context of an ICP-MS. The positioning gas is used for the purpose of positioning the plasma, while the cooling gas is used for cooling. In the case shown in FIG. 1, gas mixtures based on argon are used for the positioning gas and the cooling gas.

A heating gas, which is guided from the detector 2 back into the gas chromatograph 1 through a heating gas line 13, also has a composition based on argon. Inside the heating zone 7, the heating gas line 13 forms a heating spiral 14, through which the heating gas is essentially heated to the operating temperature existing in the heating zone 7. The heating gas is also guided in the heating zone 7 to a heating gas connection 19 via connection parts 15 and 16 and connection lines 17 and 18 and fed there into the connection part 9.

The heating gas is mixed with the carrier gas and the analytes from the separating column 6 in the transfer line 10. The mixing procedure is performed through diffusion and turbulence. The mixing procedure causes the carrier gas to also be included as a component in a condensate of analyte. Such a condensate, however, has a lower boiling temperature than a condensate made of a pure analyte. Therefore, the completely mixed gas mixture in the transfer line does not condense out even if the temperature of the transfer line 10 falls to values below the boiling temperature of the particular analytes. In order to prevent the high-boiling or ultra high-boiling analytes from condensing out in a gas mixture which is not completely mixed, the connection part 9 and the adjoining section of the transfer line 10 are located inside the heating zone 7 of the gas chromatograph 1 in the exemplary embodiment shown in FIG. 1. In this way, the connection part 9 and the section of the transfer line 10 adjoining the connection part 9 are kept at approximately the current operating temperature of the heating zone 7 until the mixing procedure is terminated. Since the heating gas introduced through the heating gas line 13 into the heating zone 7 also has essentially the temperature of the heating zone 7, the danger does not arise that the gas mixture will be locally undercooled in the transfer line 10 and the analytes will condense out. Rather, the temperature gradient implemented along the transfer line 10 prevents the analytes from condensing out.

In the present case, the gas coming out of the separating column 6 is diluted by the heating gas from the heating gas line in a ratio of at least 1:1000. This dilution ratio causes a reduction in boiling point of approximately 100° C. This additional dilution occurs in addition to the dilution of the analytes by the carrier gas occurring in the separating column, through which the boiling point has already been reduced from 550° C. to 300° C., for example. A further reduction in boiling point occurs due to the additional dilution using the heating gas, so that in the present case, analytes having a boiling temperature of 420° C. may be transported through the transfer line even if the temperature along the transfer line 10 falls to a minimum of 140° C.

In addition to the reduction of the boiling point, the dilution also causes the transfer line 10 to be protected from overheating. If, for example, the heating gas has a temperature of 300° C., the heating gas prevents an initial part of the transfer line 10 in the heating zone 7 from heating to the operating temperature of 550° C. temporarily existing there.

In addition, of course, the hot heating gas from the heating line 13 also contributes to heating of the transfer line 10.

In order to additionally heat the transfer line 10, the transfer line 10 and the heating gas line 13 are connected to an AC current source 20, which applies a heating current to both the transfer line 10 and the heating gas line 13. The heating gas flowing in the heating gas line 13 is preheated by the heating current flowing in the heating gas line 13. In addition, the heating current flowing over the transfer line 10 keeps it at a predetermined minimum temperature. In order to prevent the transfer line 10 from overheating inside the heating zone 7, the section of the transfer line 10 lying in the heating zone 7 is short-circuited using a current link 21. In this way, overheating of the transfer line 10 is prevented, so that the analytes present in the transfer line 10 are not decomposed.

It is to be noted that if the transfer line 10 and the heating line 13 are designed differently, the transfer line 10 and the heating line 13 may each have their own AC current source provided, which each heat the transfer line 10 and the heating line 13 separately.

A suction line 22, which leads to a vacuum pump 25 via a valve 23 and a pressure regulator 24, is also connected to the connection part 15. The solvent, which leaves the separating-column 6 even before the analytes, may be suctioned off with the aid of the vacuum pump 25 and the suction line 22, so that the solvent does not reach the detector 2. The pressure regulator 24 is used for the purpose of setting the pressure in the suction line 22. The pressure in the suction line 22 is selected as much as possible so that the solvent fed into the transfer line 10 is suctioned off and the plasma burning in the detector 2 is not suctioned into the transfer line 10. Finally, in order to control the pressure existing in the suction line 2, a manometer 26 is provided.

The suctioning off of the solvent is very advantageous, since no carbon deposits, which corrupt the measurement result, may then form on the torch of the detector 2.

The heating gas from the heating gas line 13, which is flushed through the connection part 9 and the transfer line 10, also contributes to the removal of the solvent vapors.

It is to be noted that further gas chromatographs 28 may be connected to the detector 2 via a connection line 27. The connection line 27 may additionally be used for feeding a calibration gas into the detector 2.

In the following, an exemplary embodiment which has been used for test purposes is to be described.

A device of the firm HP having the name HP 6890 was used as the gas chromatograph 1. The temperature in the heating zone 7 was kept at 50° C. for 3 minutes and then heated up to a final temperature of 320° C. at a heating rate of 30° C. per minute. The carrier gas was helium, to which xenon was added at 10 vpm. The flow rate of helium was 2 ml per minute. An injector of the firm HP with the name HP 7683 was used as the injector 4. The separating column 6 of type HP 5MS has a length of 30 m. The inner diameter of the separating column 6 is 0.25 mm and the film thickness is 0.25 μm.

Pipelines made out of activated stainless steel of 1.6 mm outer diameter and 1.1 mm inner diameter were used for the transfer line 10. T-shaped and X-shaped Swagelok connectors are used for the connection part 9 and the connection parts 15 and 16. It was found that tubes having 3 mm inner diameter are also suitable for the transfer line 10. A 15 cm long quartz capillary of 0.42 mm outer diameter was used for the capillary 8. The capillary 8 projects approximately 2 cm into the transfer line 10 and was connected to the connection part 9 using a reducing ferrule from 1.6 mm to 0.42 mm. The transfer line 10 was sealed at the entrance of the so called torch of the detector 2. The transfer line 10 was led to the outside through the upper wall of the gas chromatograph 1 through a simple hole and insulated using a PTFE hose. The heating gas line 13, also manufactured from stainless steel, which is used for supplying and pre-heating the heating gas, and the transfer line 10 had a heating current applied to them. The heating current source 20 provided a current of 7 A and a voltage of 10 V in this case.

An ICP-MS of the type Perkin Elmer Elan having an output of 1.050 W was used as the detector 2. The flow of the cooling gas was 13 l/minute and the flow of the positioning gas was approximately 1 l/minute. An argon gas flow at 0.6 l/minute was used as the “nebulizer gas”, to which O₂ was added at a flow rate of 0.01 l/minute. The ICP-MS was optimized for operation using dry plasma.

FIGS. 2 through 5 show some of the gas chromatograms which were recorded using this exemplary embodiment. The temperature of the transfer line 10 was kept at a temperature of 140° C. outside the gas chromatograph 1 in this case. 20 μl of a solution containing organotin were injected into the gas chromatograph 1. In FIG. 2, the gas chromatogram for the xenon contained in the carrier gas is shown. FIG. 3 also shows a gas chromatogram of ¹³C, which displays the solvent concentration. Via a relay controlled by the gas chromatograph 1, the valve 23 and the vacuum pump 25 were switched in such a way that the flow in the transfer line 10 was reversed during the elution of the solvent, so that the solvent did not reach the detector 2. A needle valve used as a pressure regulator 24 limited the vacuum in the transfer line to 0.03 bar, so that the plasma was not suctioned out of the detector 2 into the transfer line 10. Therefore, a significant reduction of the measurement signal may be seen in FIGS. 2 and 3 between 0 and 42 seconds retention time.

After 240 seconds retention time, the valve 23 was closed. Accordingly, the lines of organotin compounds appeared in the chromatogram illustrated in FIG. 4, which are each indicated in FIG. 4 using their abbreviation. The abbreviations have the following meanings: TMT: trimethyl tin, DMT: dimethyl tin, TTET: tetraethyl tin, TET: triethyl tin, MMT: monomethyl tin, D-tert-BT: di-tertiary-butyl tin, MBT: monobutyl tin, DBT: dibutyl tin, TBT: tributyl tin, TTBT: tetrabutyl tin, MPhT: monophenyl tin, MOT: monooctyl tin, DPhT: diphenyl tin, DOT: dioctyl tin, TPhT: triphenyl tin, TTPhT: tetraphenyl tin.

50 pg of each of the organotin compounds was provided in the solution in this case. 100 pg was added in the case of TTPhT only. TTPhT boils at approximately 410° C. and could be detected although the temperature of the transfer line 10 was only 140° C. outside the gas chromatograph 1.

FIG. 5 shows an enlarged section of the gas chromatogram from FIG. 4. It may be seen that the bases of the lines have no widening. This indicates that the analytes did not condense out in the transfer line 10.

It is to be noted that if the temperature of the transfer line 10 was increased to 270° C., analytes having a boiling temperature of 550° C. could be analyzed.

Finally, FIG. 6 shows a calibration chromatogram for ¹³C, which was recorded for a calibration solution having n-alkanes. 100 ng C of each of C8, C12, C14 and C18 to C26 was added to the solvent. 200 ng C of C16 was added to the solvent for calibration purposes. 200 μl of the solution was injected into the separating column 6. The temperature of the transfer line 10 was 140° C. The result of the measurement is shown in FIG. 6. The peak indicated with “solvent” identifies the impurities of the solvent. Otherwise, it may be seen that the areas of the lines have approximately the same values and the lines have no base broadening.

The dilution with the heating gas before the transfer line 10 and the improved heating of the transfer line 10 is also used for the purpose of making the entrance of the transported analytes into the detector 2 uniform. In this way, the precision of the signal size, in particular the repeatability, is increased in the event of repeated analyses.

This is to be explained particularly on the basis of the exemplary embodiment shown in FIG. 1 having an ICP-MS as detector 2.

Due to the dilution and improved heating of the transfer line 10, variations in regard to repeatability occur in the range of only 1 to 3% in the entire boiling temperature range of the analytes investigated, from monobutyl tin to tetraphenyl tin.

Without dilution of the gas coming out of the separating column 6 in the connection part 9, the gas flow of the separating column enters the torch of the detector 2 partially undiluted and is only diluted with argon there. The dilution zone in the torch has turbulence, however. The turbulence leads to variations in regard to the direction of the gas flow. In addition, the thin, highly flexible separating column 6 may be moved in random and unintended ways by the turbulence. This leads to variations of the signals in the range of 20% and is a problem of typical transfer devices.

Without heating of the transfer line 10, variations in the completeness of the transport occur with high-boiling analytes. In the boiling temperature range extending from the boiling temperature of monobutyl tin up to the boiling temperature of tributyl tin, this leads to a strongly increasing error, or expressed generally, to the analysis error becoming worse and worse with increasing boiling temperature of analytes.

Using the dilution described here and the improved heating, variations of only within 1.38% occur in the boiling temperature range up to the boiling temperature of tetrabutyl tin (somewhat higher boiling point than tributyl tin). In the boiling temperature range up to the boiling temperature of tetraphenyl tin (boiling point at 420° C., i.e., 200° C. above the boiling point of tetrabutyl tin) the variations are below 3%.

The measurement results for repeatability and limit of detection (=LOD) are summarized in Table 1:

TABLE 1

| | TMT | TTET | DBT | TTBT | DOT | TPhT | TTPhT |
|---|---|---|---|---|---|---|---|
| Repeatability, uncorrected/% | 1.62 | 1.25 | 1.13 | 1.38 | 1.34 | 2.10 | 2.91 |
| Repeatability, Xe-corrected/% | 2.81 | 2.94 | 2.10 | 3.46 | 1.93 | 2.23 | 2.79 |
| LOD (Xe-corrected)/fg | 95 | 68 | 82 | 72 | 97 | 250 | 110 |
| Linearity from LOD up to/ng | 5 | 5 | 5 | 5 | 5 | 5 | 5 |

It is to be noted that for the transport device described here, transfer lines 10 having nearly any arbitrary length may be used. For example, it is also possible to construct a transport device having a 10 m long transfer line.

Furthermore, it is to be noted that the connection part 9 may in principle also be positioned outside the heating zone 7. In this case, however, an additional heating device is to be provided for heating the connection part 9 and the adjoining section of the transfer line 10.

1. A transport device for transporting an analyte from a gas chromatograph (1) into a detector (2), having a transfer line connectable on the outlet side to the detector and connected on the inlet side to a connection part (9), which is connectable to a separating column (6) of the gas chromatograph (1) and which comprises an auxiliary gas connection (19) for feeding an auxiliary gas into the transfer line (10),
characterized in that
gas flowing out of the separating column (6) into the transfer line (10) may be mixed with the auxiliary gas fed through the auxiliary gas connection (19) and a temperature profile along the transfer line (10) which falls toward the detector (2) is producible by a heating device (7, 20) during a measurement.

2. The transport device according to claim 1, wherein the heating device (7, 20) acts on the transfer line (10) outside the connection part (9).

3. The transport device according to claim 1 or 2, wherein, at the maximum operating temperature of the gas chromatograph (1), the temperature difference between the temperature of the transfer line (10) adjoining the connection part (9) and the operating temperature of a heating zone (7) in the gas chromatograph (1) is smaller than the temperature difference between the temperature of the transfer line (10) adjoining the connection part (9) and the temperature of the transfer line (10) adjoining the detector (2).

4. The transport device according to one of claims 1 to 3, wherein the temperature of the connection part (9) is between 300 and 550° C.

5. The transport device according to one of claims 1 to 4, wherein the temperature of the transfer line (10) near the detector (2) lies in the range between 100 and 300° C.

6. The transport device according to one of claims 1 to 5, wherein the connection part (9) is positioned inside the gas chromatograph (1).

7. The transport device according to claim 6, wherein the connection part (9) is positioned inside a heating zone (7) of the gas chromatograph (1), which encloses the separating column (6).

8. The transport device according to one of claims 1 to 7, wherein the transfer line (10) is manufactured from a metallic material having low thermal conductivity.

9. The transport device according to claim 7 or 8, wherein the transfer line (10) is heated with the aid of heating means outside the gas chromatograph (1).

10. The transport device according to claim 9, wherein the transfer line (10) is heated with the aid of a heating current flowing through the transfer line (10).

11. The transport device according to claim 10, wherein a section of the transfer line (10) running inside the gas chromatograph (1) is short-circuited.

12. The transport device according to claim 11, wherein a section of the transfer line (10) running in the inside of a heating zone (7) in the gas chromatograph (1) is short-circuited.

13. The transport device according to one of claims 1 to 12, wherein the transfer line (10) is connected to a suction device.

14. The transport device according to claim 13, when the transfer line (10) is connected to a pump (25) via a valve (23).

15. The transport device according to one of claims 1 to 14, wherein the auxiliary gas is heated with the aid of a heating device (7, 14, 20).

16. The transport device according to claim 15, wherein an auxiliary gas line (13), which is connected to the auxiliary gas connection (19), is heated with the aid of a heating device (7, 14, 20).

17. The transport device according to claim 15 or 16, wherein the auxiliary gas line (13) is guided through a heating zone (7) in the gas chromatograph (1) to the connection part (9).
